(19) United States
(12) Patent Application Publication
(10) Pub. No.: US 2015/0029333 A1
(43) Pub. Date: Jan. 29, 2015

(54) NETWORK SURVEILLANCE SYSTEM, WIRELESS NETWORK SURVEILLANCE APPARATUS AND SETTING METHOD THEREOF

(71) Applicant: SONIX Technology Co., Ltd., Hsinchu (TW)

(72) Inventors: Chung-Chih Ko, Hsinchu County (TW); Ming-Chih Wu, Hsinchu County (TW); Tsang-Te Tsai, Hsinchu County (TW); Shih-Chang Chen, Hsinchu County (TW)

(21) Appl. No.: 14/340,565

(22) Filed: Jul. 25, 2014

(30) Foreign Application Priority Data
Jul. 26, 2013 (TW) 102126936

(51) Int. Cl. H04N 7/18; H04B 5/00; H04W 48/20; H04W 76/02

(52) U.S. Cl. CPC H04N 7/18; H04W 76/02; H04B 5/0025; H04W 48/20
USPC 348/143

(57) ABSTRACT

A network surveillance system, a wireless network surveillance apparatus, and a setting method of the wireless network surveillance apparatus are provided. The method includes following steps: obtaining at least one connection information for connecting a wireless network surveillance apparatus; connecting the wireless network surveillance apparatus according to the at least one connection information; obtaining an access point (AP) list and displaying the AP list on a user interface unit; after a user selects from the AP list a specific to-be-connected AP through the user interface unit and enters a password corresponding to the specific AP, controlling the wireless network surveillance apparatus to connect the specific AP through a wireless connection according to the password.

### CROSS-REFERENCE TO RELATED APPLICATION

This application claims the priority benefit of Taiwan application serial no. 102126936, filed on Jul. 26, 2013. The entirety of the above-mentioned patent application is hereby incorporated by reference herein and made a part of this specification.

### BACKGROUND

1. Field of the Invention

The invention relates to a surveillance system, a surveillance apparatus, and a setting method of the surveillance apparatus; more particularly, the invention relates to a network surveillance system, a wireless network surveillance apparatus, and a setting method of the wireless network surveillance apparatus.

2. Description of Related Art

Network initialization settings of a conventional interne protocol camera (IP cam) can be completed by inputting network connection parameters only through a personal computer. In the event that the IP cam is required to provide the wireless connection, the setup of the network connection parameters is rather complicated, for instance, searching a wireless AP base station, setting a password for accessing the AP base station, setting a base station network packet forwarding address, etc. The IP cam can be connected to the network only after said wireless network initialization settings are completed, which causes great inconvenience to users who are not familiar with the computer basics.

In addition, if a mobile device intends to access surveillance images taken by the IP cam, data packets associated with the surveillance images may be blocked by the firewall of the mobile device, such that the surveillance images cannot be successfully sent to the mobile device.

### SUMMARY OF THE INVENTION

Accordingly, the invention is directed to a network surveillance system, a wireless network surveillance apparatus, and a setting method of the wireless network surveillance apparatus, such that a user is allowed to set up an IP camera with ease through a simple user interface on a mobile device.

In an embodiment of the invention, a wireless network surveillance apparatus that includes an image sensing module, a wireless network module, and a network connection tag is provided. The network connection tag includes at least one connection information associated with the wireless network surveillance apparatus. After a user obtains the at least one connection information through a mobile device, the wireless network module is connected to the mobile device and receives a connection setting of a specific access point (AP) from the mobile device.

According to an embodiment of the invention, the network connection tag is a code pattern.

According to an embodiment of the invention, the network connection tag is a near field communication (NFC) tag.

In an embodiment of the invention, a setting method of a wireless network surveillance apparatus includes following steps. A wireless network surveillance apparatus having a network connection tag is provided. At least one connection information associated with the wireless network surveillance apparatus is obtained by the mobile device from the network connection tag. According to the at least one connection information, the mobile device is connected to the wireless network surveillance apparatus, and the wireless network surveillance apparatus receives a connection setting of a specific AC from the mobile device.

According to an embodiment of the invention, the mobile device further obtains registration information of the wireless network surveillance apparatus through the network connection tag.

According to an embodiment of the invention, the mobile device further registers on a server the wireless network surveillance apparatus based on the registration information.

In an embodiment of the invention, a setting method of a wireless network surveillance apparatus is provided, and the setting method is adapted to a network surveillance system that includes at least one AP, a server, a wireless network surveillance apparatus. The setting method includes following steps. At least one connection information for connecting the wireless network surveillance apparatus is obtained by the mobile device. The wireless network surveillance apparatus is connected to the mobile device according to the at least one connection information. An AP list is obtained by the mobile device, and the AP list is displayed on a user interface unit of the mobile device. After a user of the mobile device selects from the AP list a specific to-be-connected AP through the user interface unit and enters a password corresponding to the specific AP, the wireless network surveillance apparatus is controlled by the mobile device to connect the specific AP through a wireless connection according to the password.

According to an embodiment of the invention, after the step of obtaining the at least one connection information for connecting the wireless network surveillance apparatus by the mobile device, the setting method further includes: registering on the server the wireless network surveillance apparatus by the mobile device according to a unique identifier (UID) of the wireless network surveillance apparatus.

According to an embodiment of the invention, after the step of controlling the wireless network surveillance apparatus by the mobile device to connect the specific AP through the wireless connection according to the password, the setting method further includes: accessing a surveillance image by the mobile device through the server. The surveillance image described herein is sent from the wireless network surveillance apparatus to the server.

According to an embodiment of the invention, the step of obtaining the AP list by the mobile device includes: receiving the AP list from the wireless network surveillance apparatus by the mobile device. Here, the AP list includes at least one AP searched by the wireless network surveillance apparatus.

According to an embodiment of the invention, the step of obtaining the AP list by the mobile device includes: searching at least one AP by the mobile device to generate the AP list that includes the at least one AP.

According to an embodiment of the invention, after the step of controlling the wireless network surveillance apparatus by the mobile device to connect the specific AP through the wireless connection according to the password, the setting method further includes: when an electronic apparatus connected to the server sends an access request to the server for accessing a surveillance image captured by the wireless network surveillance apparatus, camouflaging a data packet associated with the surveillance image as a hypertext transfer protocol (HTTP) packet by the server and transmitting the camouflaged data packet to the electronic apparatus by the server.

According to an embodiment of the invention, after the step of controlling the wireless network surveillance apparatus by the mobile device to connect the specific AP through the wireless connection according to the password, the setting method further includes: performing a handshake process through the specific AP by the server and the wireless network surveillance apparatus, so as to open at least one communication port on the specific AP. Here, the at least one communication port is configured to send a surveillance image captured by the wireless network surveillance apparatus.

In an embodiment of the invention, a network surveillance system includes at least one AP, a peer-to-peer communication server, a network surveillance camera, and a first smart phone. The peer-to-peer communication server is connected to the at least one AP. The first smart phone is connected to the peer-to-peer communication server and configured to obtain at least one connection info nation for connecting the network surveillance camera, connect the network surveillance camera according to the at least one connection information, obtain an AP list, and display the AP list on a user interface unit of the first smart phone. After a user of the first smart phone selects from the AP list a specific to-be-connected AP through the user interface unit and enters a password corresponding to the specific AP, the first smart phone is further configured to control the network surveillance camera to connect the specific AP through a wireless connection according to the password.

According to an embodiment of the invention, the first smart phone registers the network surveillance camera on the peer-to-peer communication server according to a UID of the network surveillance camera.

According to an embodiment of the invention, the first smart phone further accesses a surveillance image through the peer-to-peer communication server. Here, the surveillance image is sent from the network surveillance camera to the peer-to-peer communication server.

According to an embodiment of the invention, the first smart phone receives the AP list from the network surveillance camera, and the AP list includes at least one AP searched by the network surveillance camera.

According to an embodiment of the invention, the first smart phone searches at least one AP to generate the AP list that includes the at least one AP.

According to an embodiment of the invention, when a second smart phone connected to the peer-to-peer communication server sends an access request to the peer-to-peer communication server for accessing a surveillance image captured by the network surveillance camera, the peer-to-peer communication server camouflages a data packet associated with the surveillance image as a HTTP packet and transmits the camouflaged data packet to the second smart phone.

According to an embodiment of the invention, the peer-to-peer communication server and the network surveillance camera perform a handshake process through the specific AP, so as to open at least one communication port on the specific AP, and the at least one communication port is configured to send a surveillance image captured by the network surveillance camera.

In view of the setting method of the wireless network surveillance apparatus, the mobile device, and the network surveillance system described above, if the user intends to install and set up the wireless network surveillance apparatus, the user is able to complete the settings of the wireless network surveillance apparatus merely by performing simple processes through the mobile device, e.g., obtaining the connection information of the wireless network surveillance apparatus, selecting the specific AP for connecting the wireless network surveillance apparatus, and entering the password corresponding to the specific AP.

Several exemplary embodiments accompanied with figures are described in detail below to further describe the invention in details.

### BRIEF DESCRIPTION OF THE DRAWINGS

FIG. 1 is a schematic diagram illustrating a network surveillance system according to an embodiment of the invention.

FIG. 2A is a schematic flowchart illustrating a setting method of a wireless network surveillance apparatus according to an embodiment of the invention.

FIG. 2B is a schematic flowchart illustrating a setting method of a wireless network surveillance apparatus according to an embodiment of the invention.

FIG. 3 is a schematic diagram illustrating a network surveillance system according to another embodiment of the invention.

FIG. 4A to FIG. 4E are schematic flowcharts illustrating a setting method of a wireless network surveillance apparatus according to an embodiment of the invention.

### DETAILED DESCRIPTION OF DISCLOSED EMBODIMENTS

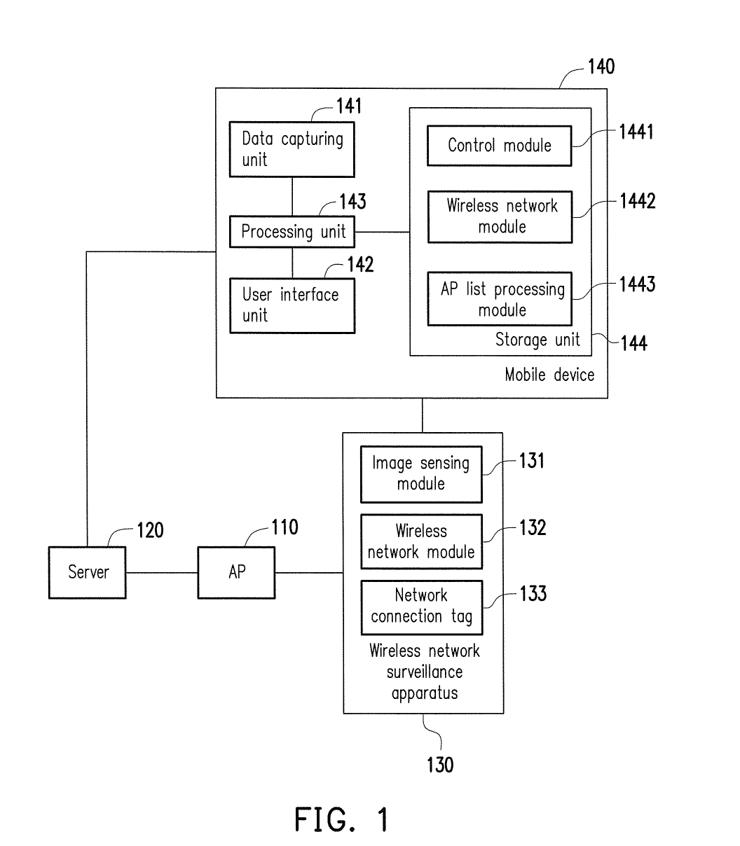

FIG. 1 is a schematic diagram illustrating a network surveillance system according to an embodiment of the invention. In the present embodiment, the network surveillance system 100 includes an access point (AP) 110, a server 120, a wireless network surveillance apparatus 130, and a mobile device 140. The AP 110 is, for instance, a wireless fidelity (Wi-Fi) wireless router or a mobile device (e.g., a software AP) that is able to share its wireless connection (e.g., a Wi-Fi network or a 3G network) to the devices for internet connection; however, the invention is not limited thereto. Note that the AP and the router described below have substantially the same meaning. The server 120 is connected to the AP 110 and is a peer-to-peer (P2P) communication server that can be configured to record information of each wireless network surveillance apparatus (e.g. the wireless network surveillance apparatus 130), for instance. In an embodiment of the invention, if a certain mobile device intends to access a surveillance image captured by the wireless network surveillance apparatus 130 through the server 120, the server 120 is able to assist in processing the data packet associated with the surveillance image, such that the data packet is able to bypass the firewall of the mobile device, which will be elaborated hereinafter.

The wireless network surveillance apparatus 130 is, for instance, an IP camera (cam) or any other electronic apparatus capable of providing the surveillance image (captured by itself) through network connection. In an embodiment of the invention, the wireless network surveillance apparatus 130 may be implemented in form of the software AP and may contain service set identifier (SSID) information that allows the connection to other apparatuses. The wireless network surveillance apparatus 130 may include an image sensing module 131, a wireless network module 132, and a network connection tag 133. The image sensing module 131 is, for instance, an image capturing device implemented in form of a charge coupled device (CCD) and or a complementary metal oxide semiconductor (CMOS) and can be configured to capture the image within the surveillance range of the wireless network surveillance apparatus 130. The wireless network module 132 is, for instance, a Wi-Fi module and can be connected to an AP (e.g., the AP 110), a router, or other devices and can further send the image captured by the image sensing module 131. The network connection tag 133 is, for instance, a code pattern printed on the wireless network surveillance apparatus 130 or a near field communication (NFC) tag that may include various connection information associated with the wireless network surveillance apparatus 130. The mobile device 140 is, for instance, a smart phone, a tablet PC, a notebook computer, a personal digital assistant (PDA), a personal computer, or any other electronic apparatus that can access images through network connection and display the images. Here, the mobile device 140 may include a data obtaining unit 141, a user interface unit 142, a storage unit 144, and a processing unit 143. The user interface unit 142 is, for instance, a touch screen or any other device capable of displaying information of the mobile device 140 and receiving the input operation from users. The storage unit 144 records plural modules. For instance, the storage unit 144 is a memory, a hard drive, or any other device which may be used to store data. The modules include a control module 1441, a wireless network module 1442, and an AP list processing module 1445 and can be stored in form of programming codes in the storage unit 144.

The processing unit 143 is coupled to the data obtaining unit 141, the user interface unit 142, and the storage unit 144. Besides, the processing unit 143 may access and process data stored in the control module 1441, the wireless network module 1442, and the AP list processing module 1443 recorded in the storage unit 144. Here, the processing unit 143 may be a general processor, a specific processor, a conventional processor, a processor capable of processing digital signals, a plurality of microprocessors, one or more microprocessors combining cores of the processor capable of processing digital signals, a controller, a microcontroller, an application specific integrated circuit (ASIC), a field programmable gate array (FPGA), any other integrated circuit, a state machine, an advanced RISC machine (ARM) processor, and the like.

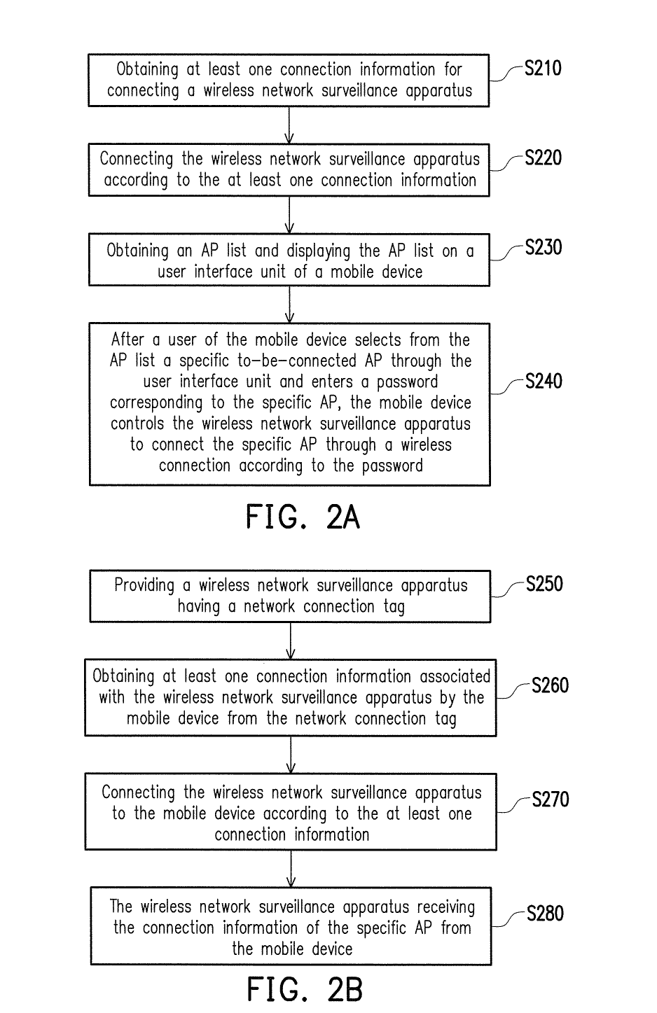

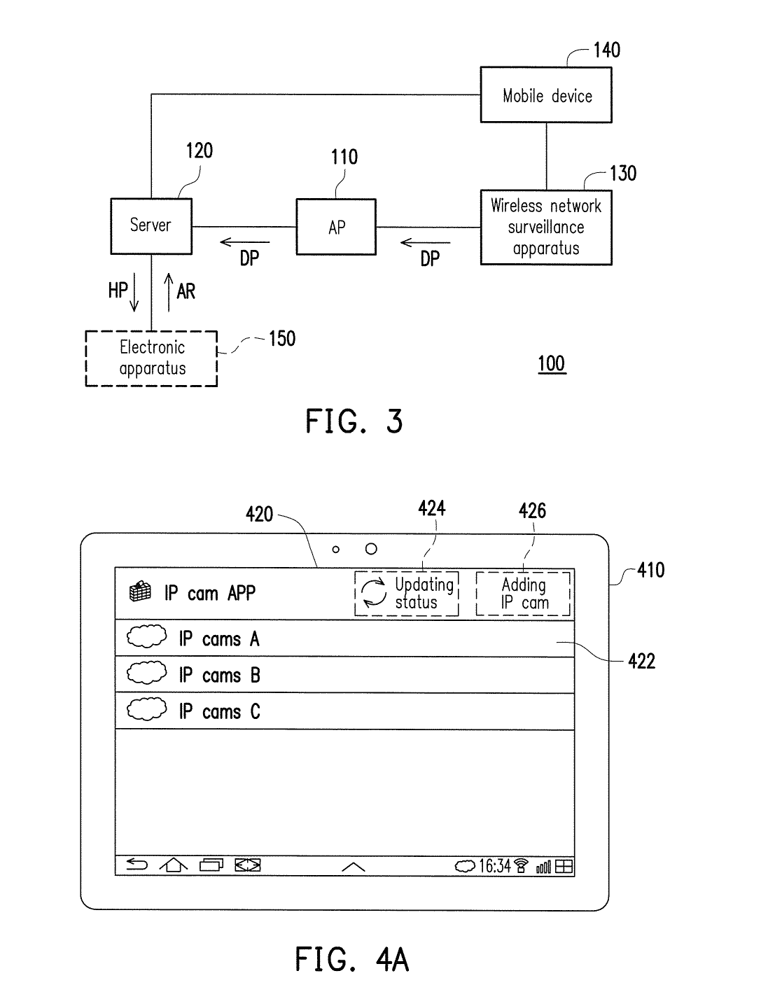

FIG. 2A is a schematic flowchart illustrating a setting method of a wireless network surveillance apparatus according to an embodiment of the invention. The setting method described in the present embodiment is suitable for the network surveillance system 100 depicted in FIG. 1, and each step of the setting method is explained hereinafter with reference to the devices shown in FIG. 1.

In step S210, the control module 1441 of the mobile device 140 controls the data capturing unit 141 to obtain at least one connection information for connecting the wireless network surveillance apparatus 130. The at least one connection information includes, for instance, the SSID of the wireless network surveillance apparatus 130, a connection password, and a unique identification (UID). The connection password allows the mobile device 140 to control or access the wireless network surveillance apparatus 130, for instance.

According to an embodiment of the invention, the connection password as well as the UID and the SSID of the wireless network surveillance apparatus 130 can be integrated in form of a code pattern (e.g., the aforesaid network connection tag) by designers, and the code pattern may be printed on the casing or the packaging material of the wireless network surveillance apparatus 130, for instance. Here, the code pattern is, for instance, a quick response (QR) code, a bar code, or the like. If the at least one connection information is shown on the wireless network surveillance apparatus 130 in form of the code pattern, the user of the mobile device 140 may capture the code pattern of the wireless network surveillance apparatus 130 through the data capturing unit 141 implemented in form of an image capturing device (e.g., a lens), so as to obtain the connection information (i.e., the connection password as well as the UID and the SSID) of the wireless network surveillance apparatus 130.

In another embodiment of the invention, the data capturing unit 141 may also be implemented in form of an NFC device. The NFC device can be configured to communicate with the wireless network surveillance apparatus 130 in an NFC manner and thereby obtain the connection information of the wireless network surveillance apparatus 130. Specifically, when the wireless network surveillance apparatus 130 and the mobile device 140 are both equipped with the device capable of performing the NFC function, the user may trigger the NFC function of the wireless network surveillance apparatus 130 and the mobile device 140 by slightly touching the wireless network surveillance apparatus 130 with the mobile device 140; thereby, the mobile device 140 is able to obtain the connection information (i.e., the connection password as well as the UID and the SSID) of the wireless network surveillance apparatus 130 through the NFC tag of the wireless network surveillance apparatus 130, for instance.

Alternatively, if the user of the mobile device 140 and the wireless network surveillance apparatus 130 is already aware of the connection information (i.e., the connection password as well as the UID and the SSID) of the wireless network surveillance apparatus 130, the user may input such connection information to the mobile device 140 through the user interface unit 142 on his or her own, so as to allow the mobile device 140 to obtain the connection information.

In step S220, the mobile device 140 may be connected to the wireless network surveillance apparatus 130 according to the at least one connection information (i.e., the connection password as well as the UID and the SSID). Particularly, the mobile device 140 is able to connect the wireless network provided by the wireless network surveillance apparatus 130 according to the connection password and the SSID of the wireless network surveillance apparatus 130.

According to another embodiment of the invention, after the mobile device 140 is connected to the wireless network surveillance apparatus 130, the mobile device 140 may be further connected to the server 120 through the mobile communication network (e.g., 3G, 4G, or the like) of the mobile device 140 and may register the wireless network surveillance apparatus 130 on the server 120 according to the UID of the wireless network surveillance apparatus 130. From another perspective, the UID of the wireless network surveillance apparatus 130 may be considered as the registration information of the wireless network surveillance apparatus 130.

In step S230, the AP list processing module 1443 of the mobile device 140 may obtain an AP list and display the AP list on the user interface unit 142. The AP list may be displayed on the user interface unit 142 in form of a dialog box that may include an SSID list corresponding to different APs, for instance.

According to an embodiment of the invention, the wireless network surveillance apparatus 130 may spontaneously search nearby APs (e.g., the AP 110) and then organize the searched APs, so as to correspondingly generate the AP list. After that, the wireless network surveillance apparatus 130 can send the AP list generated by itself to the mobile device 140. Hence, after receiving the AP list from the wireless network surveillance apparatus 130, the mobile device 140 is able to correspondingly display the AP list on the user interface unit 142.

According to another embodiment of the invention, the mobile device 140 may spontaneously search APs (e.g., the AP 120) around the wireless network surveillance apparatus 130 and correspondingly generate the AP list that includes the searched APs.

After the user display unit 142 displays the AP list, the user may select a specific to-be-connected AP for controlling the wireless network surveillance apparatus 130 and input the password corresponding to the specific AP. For instance, if the user intends to control the wireless network surveillance apparatus 130 to connect the Wi-Fi network provided by the AP 110, the user may select the SSID of the AP 110 from the AP list and then input the password corresponding to the AP 110.

In step S240, after the user of the mobile device 140 selects from the AP list the specific to-be-connected AP through the user interface unit 142 and enters the password corresponding to the specific AP, the mobile device 140 controls the wireless network surveillance apparatus 130 to connect the specific AP (e.g., the AP 110) through a wireless connection according to the password. In particular, the mobile device 140 may, through its wireless network module 1442, control the wireless network surveillance apparatus 130 to connect the specific AP (e.g., the AP 110).

According to another embodiment of the invention, after the wireless network surveillance apparatus 130 is connected to the specific AP (e.g., the AP 110), the server 120 and the wireless network surveillance apparatus 130 may perform a handshake process through the AP 100, so as to open a communication port on the AP 110 configured to send a surveillance image captured by the wireless network surveillance apparatus 130.

In brief, if the user intends to install and set up the wireless network surveillance apparatus 130 (e.g., an IP cam), the user is able to complete the settings of the wireless network surveillance apparatus 130 merely by performing simple processes through the mobile device 140, e.g., obtaining the connection information of the wireless network surveillance apparatus 130 (for instance, capturing the mobile barcode of the wireless network surveillance apparatus 130), selecting the specific AP (e.g., the AP 110) for connecting the wireless network surveillance apparatus 130, and entering the password corresponding to the specific AP. In addition, the server 120 and the wireless network surveillance apparatus 130 already open the communication port on the AP 110 through performing the handshake process, and thus the user need not perform complicated and difficult processes required for setting the conventional IP cam while installing the wireless network surveillance apparatus 130. For instance, the user is neither required to set up the IP address of the IP cam nor required to login to the webpage for the AP acting as the network address translation (NAT) gateway and complete the port forwarding settings.

Once the user completes the settings of the wireless network surveillance apparatus 130 through the mobile device 140, the user can then access the surveillance image controlled by the wireless network surveillance apparatus 130 through the mobile device 140. To be specific, the mobile device 140 may be connected to the server through mobile communication (e.g., 3G, 4G, or Wi-Fi) or wireless network connection and may through the server 120 access the surveillance image sent from the wireless network surveillance apparatus 130 to the server 120. Thereby, the user can watch the surveillance image controlled by the wireless network surveillance apparatus 130 through the mobile device 140 with ease.

FIG. 2B is a schematic flowchart illustrating a setting method of a wireless network surveillance apparatus according to an embodiment of the invention. Steps in the setting method provided in the present embodiment are explained with reference to each device and apparatus depicted in FIG. 1. In step S250, a wireless network surveillance apparatus 130 having a network connection tag (e.g., a QR code) is provided. In step S260, at least one connection information (e.g., UID and/or SSID) associated with the wireless network surveillance apparatus 130 is obtained by the mobile device 140 from the network connection tag. In step S270, the mobile device 140 is connected to the wireless network surveillance apparatus 130 according to the at least one connection information. In step S280, the wireless network surveillance apparatus 130 receives the connection information (e.g., the password corresponding to the specific AP) of the specific AP (e.g., the AP 110) from the mobile device 140.

Additionally, as provided above, the mobile device 140 may obtain the UID of the wireless network surveillance apparatus 130 through the connection tag 133 and thereby register the wireless network surveillance apparatus 130 on the server 120. That is, the UID of the wireless network surveillance apparatus 130 may be considered as the registration information of the wireless network surveillance apparatus 130.

According to an embodiment of the invention, if the user intends to access the surveillance image through a mobile device with a firewall configuration, the data packet associated with the surveillance image may be blocked by the firewall, and thus the mobile device may not be able to receive the data packet associated with the surveillance image. In this case, the network surveillance system 100 provided in an embodiment of the invention may process the data packet associated with the surveillance image in a specific manner through the server 120, such that the data packet associated with the surveillance image may bypass the firewall of the mobile device, and that the mobile device is allowed to receive the data packet associated with the surveillance image. Details of the above will be provided hereinafter.

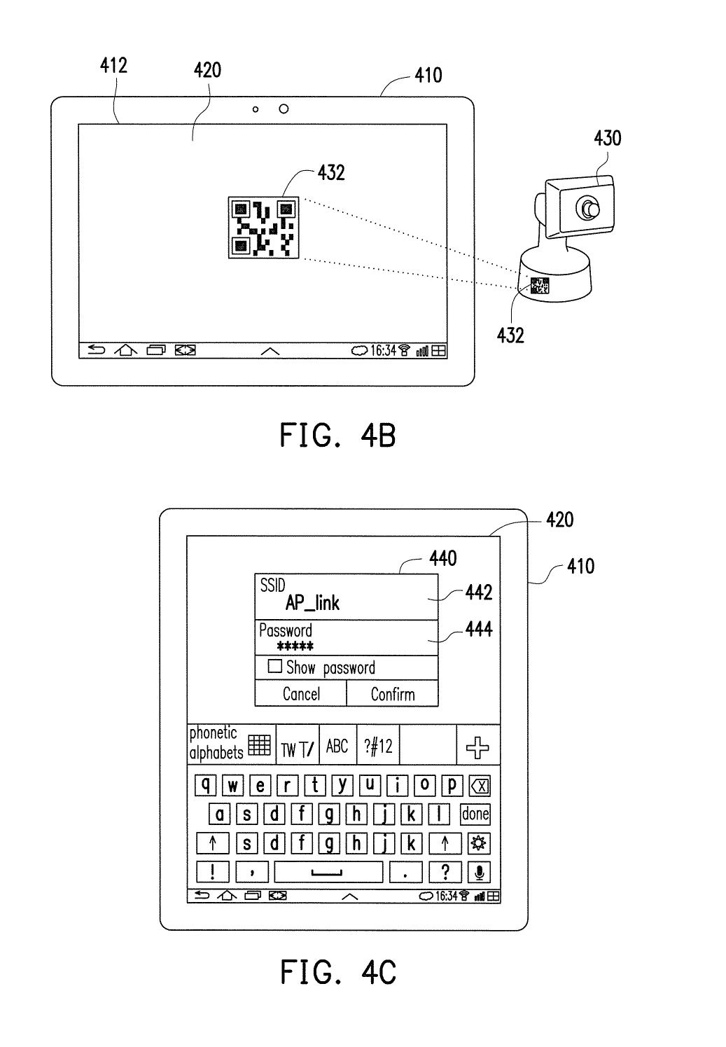

FIG. 3 is a schematic diagram illustrating a network surveillance system according to another embodiment of the invention. In the present embodiment, the network surveillance system 100 may further include an electronic apparatus 150 connected to the server 120. The electronic apparatus 150 is, for instance, a smart phone, a tablet PC, a notebook computer, a PDA, a personal computer, or any other electronic apparatus that can access images through network connection and display the images.

According to the present embodiment, when the electronic apparatus 150 sends an access request AR to the server 120 for accessing a surveillance image captured by the wireless network surveillance apparatus 130, the server 120 may camouflage a data packet DP associated with the surveillance image as a hypertext transfer protocol (HTTP) packet HP through masquerading and transmit the camouflaged data packet DP (i.e., the HTTP packet HP) to the electronic apparatus 150. Thereby, if the firewall of the electronic apparatus 150 receives the HTTP packet HP, the firewall does not block the HTTP packet HP, and the electronic apparatus 150 can then access the surveillance image captured by the wireless network surveillance apparatus 130.

That is, the server 120 can open the communication port on the AP 110 by performing the handshake process together with the wireless network surveillance apparatus 130, and the server 120 can also properly camouflage the data packet DP associated with the surveillance image when the electronic apparatus 150 is to access the surveillance image, so as to prevent the data packet DP from being blocked by the firewall of the electronic apparatus 150.

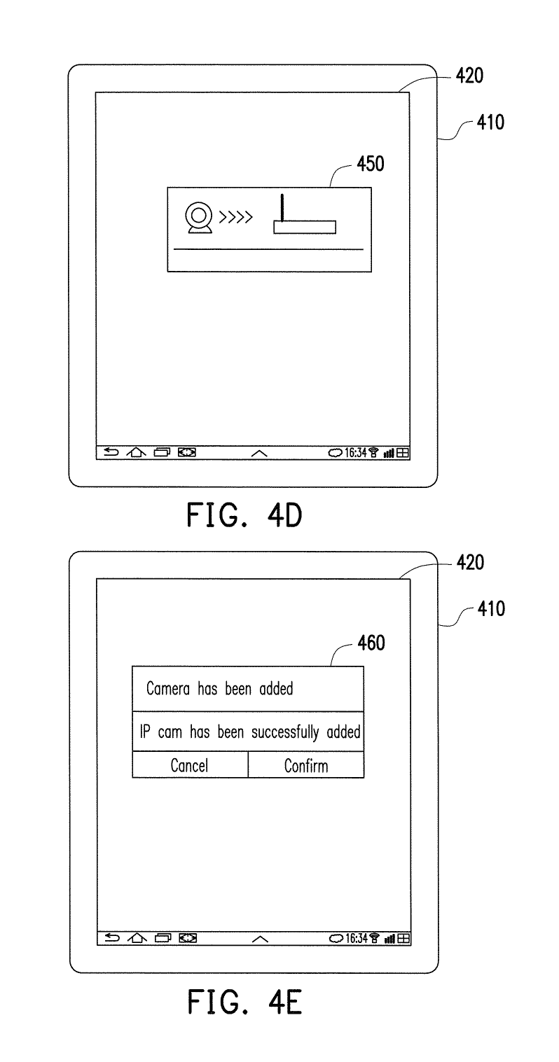

FIG. 4A to FIG. 4E are schematic flowcharts illustrating a setting method of a wireless network surveillance apparatus according to an embodiment of the invention. With reference to FIG. 4A, the user interface 420 of the mobile device 410 serves to manage the user interface of each wireless network surveillance apparatus and may include screen buttons 424 and 426 and an IP cam list 422 containing information of plural IP cams (i.e., IP cams A to C). The screen button 424 may serve to control the mobile device 410 to update the surveillance status of the IP cams A to C, for instance, and the screen button 426 may allow the user to add another IP cam, for instance. In particular, when the user of the mobile device 410 presses the screen button 426, the mobile device 410 may activate the data capturing module (e.g., a lens) for the user to subsequently capture the image of the mobile barcode of the added IP cam.

As shown in FIG. 4B, in the present embodiment, the IP cam to be added by the user is assumed to be the wireless network surveillance apparatus 430 (named as the IP cam D, for instance). After the mobile device 410 activates its data capturing module (e.g., a lens), the user may photograph the mobile barcode 432 on the wireless network surveillance apparatus 430 with use of the lens of the mobile device 410. At this time, the display image 412 of the mobile device 410 shows the captured mobile barcode 432. As provided above, after the user photographs the mobile barcode 432 on the wireless network surveillance apparatus 430 with use of the mobile device 410, the mobile device 410 can obtain the connection password as well as the UID and the SSID of the wireless network surveillance apparatus 430 from the mobile barcode 432. Besides, the mobile device 410 is able to connect the wireless network provided by the wireless network surveillance apparatus 430 according to the SSID of the wireless network surveillance apparatus 430. After that, the mobile device 410 may register on a server (not shown) the wireless network surveillance apparatus 430 according to the UID of the wireless network surveillance apparatus 430. After searching the nearby APs (not shown), the wireless network surveillance apparatus 430 can correspondingly Generate the AP list and send the AP list to the mobile device 410.

As shown in FIG. 4C, in the present embodiment, the user interface 420 of the mobile device 410 is able to display the AP list in form of a dialog box 440, for instance. The dialog box 440 may include an SSID list 442 and a password column 444. The SSID list 442 is, for instance, a pull-down type menu that allows the user to select the SSID of the to-be-connected AP.

After the user selects the SSID (e.g., AP_link) of the to-be-connected AP from the SSID list 442 and enters the password corresponding to the AP_link in the password column 444, the user interface 420 can display a connection diagram 450 showing the status of connecting the wireless network surveillance apparatus 430 to the to-be-connected AP, for instance. With reference to FIG. 4E, after the connection between the wireless network surveillance apparatus 430 and the to-be-connected AP is completed, the user interface 420 may display a message 460 to inform the user that the wireless network surveillance apparatus 430 is successfully added.

To sum up, in the setting method of the wireless network surveillance apparatus, the mobile device, and the network surveillance system described above, if the user intends to install and set up the wireless network surveillance apparatus (e.g., the IP cam), the user is able to complete the settings of the wireless network surveillance apparatus merely by performing simple processes through the mobile device, e.g., obtaining the connection information of the wireless network surveillance apparatus (for instance, capturing the mobile barcode of the wireless network surveillance apparatus with use of a lens), selecting the specific AP for connecting the wireless network surveillance apparatus, and entering the password corresponding to the specific AP. In addition, the server and the wireless network surveillance apparatus already open the communication port on the AP through performing the handshake process, and thus the user need not perform complicated and difficult processes required for setting the conventional IP cam while installing the wireless network surveillance apparatus. For instance, the user is neither required to set up the IP address of the IP cam nor required to login to the webpage for the AP acting as the network address translation (NAT) gateway and complete the port forwarding settings. Moreover, the server camouflages the data packet associated with the surveillance image through masquerading, and thus the camouflaged data packet can bypass the firewall of the mobile device. As a result, the mobile device is able to successfully receive the data packet.

Although the invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

What is claimed is:

1. A wireless network surveillance apparatus comprising:
an image sensing module;
a wireless network module; and
a network connection tag comprising at least one connection information associated with the wireless network surveillance apparatus,
wherein after a user obtains the at least one connection information through a mobile device, the wireless network module is connected to the mobile device and receives a connection setting of a specific access point from the mobile device.

2. The wireless network surveillance apparatus as recited in claim 1, wherein the network connection tag is a code pattern.

3. The wireless network surveillance apparatus as recited in claim 1, wherein the network connection tag is a near field communication tag.

4. A setting method of a wireless network surveillance apparatus, comprising:
providing a wireless network surveillance apparatus having a network connection tag;
obtaining at least one connection information associated with the wireless network surveillance apparatus from the network connection tag by a mobile device,
wherein the mobile device is connected to the wireless network surveillance apparatus according to the at least one connection information, and the wireless network surveillance apparatus receives a connection setting of a specific access point from the mobile device.

5. The setting method as recited in claim 4, wherein registration information of the wireless network surveillance apparatus is further obtained by the mobile device through the network connection tag.

6. The setting method as recited in claim 5, wherein the wireless network surveillance apparatus is further registered on a server by the mobile device according to the registration information.

7. A setting method of a wireless network surveillance apparatus, the method being adapted to a network surveillance system comprising at least one access point, a server, a wireless network surveillance apparatus, and a mobile device, the setting method comprising:
obtaining at least one connection information for connecting the wireless network surveillance apparatus by the mobile device;
connecting the wireless network surveillance apparatus to the mobile device according to the at least one connection information;
obtaining an access point list by the mobile device and displaying the access point list on a user interface unit of the mobile device; and
after a user of the mobile device selects from the access point list a specific to-be-connected access point through the user interface unit and enters a password corresponding to the specific access point, controlling the wireless network surveillance apparatus by the mobile device to connect the specific access point through a wireless connection according to the password.

8. The setting method as recited in claim 7, wherein the step of obtaining at least one connection information for connecting the wireless network surveillance apparatus by the mobile device comprising:
obtaining the at least one connection information associated with the wireless network surveillance apparatus from a network connection tag of the wireless network surveillance apparatus by the mobile device.

9. The setting method as recited in claim 8, wherein the at least one connection information comprises a connection password and a service set identifier of the wireless network surveillance apparatus.

10. The setting method as recited in claim 9, wherein the at least one connection information further comprises a unique identifier of the wireless network surveillance apparatus.

11. The setting method as recited in claim 10, after the step of obtaining the at least one connection information for connecting the wireless network surveillance apparatus by the mobile device, the setting method further comprising:
registering, by the mobile device, on the server the wireless network surveillance apparatus according to the unique identifier of the wireless network surveillance apparatus.

12. The setting method as recited in claim 11, after the step of controlling the wireless network surveillance apparatus by the mobile device to connect the specific access point through the wireless connection according to the password, the setting method further comprising:
accessing a surveillance image by the mobile device through the server, the surveillance image being sent from the wireless network surveillance apparatus to the server.

13. The setting method as recited in claim 7, the step of obtaining the access point list by the mobile device comprising:
receiving the access point list from the wireless network surveillance apparatus by the mobile device, wherein the access point list comprises at least one access point searched by the wireless network surveillance apparatus.

14. The setting method as recited in claim 7, the step of obtaining the access point list by the mobile device comprising:
searching at least one access point by the mobile device to generate the access point list comprising the at least one access point.

15. The setting method as recited in claim 7, after the step of controlling the wireless network surveillance apparatus by the mobile device to connect the specific access point through the wireless connection according to the password, the setting method further comprising:
when an electronic apparatus connected to the server sends an access request to the server for accessing a surveillance image captured by the wireless network surveillance apparatus, camouflaging a data packet associated with the surveillance image as a hypertext transfer protocol packet by the server and transmitting the camouflaged data packet to the electronic apparatus by the server.

16. The setting method as recited in claim 7, after the step of controlling the wireless network surveillance apparatus by the mobile device to connect the specific access point through the wireless connection according to the password, the setting method further comprising:
performing a handshake process through the specific access point by the server and the wireless network surveillance apparatus, so as to open at least one communication port on the specific access point, the at least one communication port being configured to send a surveillance image captured by the wireless network surveillance apparatus.

17. A network surveillance system comprising:
at least one access point;
a peer-to-peer communication server connected to the at least one access point;
a network surveillance camera; and
a first smart phone connected to the peer-to-peer communication server and configured to:
obtain at least one connection information for connecting the network surveillance camera;
connect the network surveillance camera according to the at least one connection information;
obtain an access point list and display the access point list on a user interface unit of the first smart phone; and
after a user of the first smart phone selects from the access point list a specific to-be-connected access point through the user interface unit and enters a password corresponding to the specific access point, control the network surveillance camera to connect the specific access point through a wireless connection according to the password.

18. The network surveillance system as recited in claim 17, wherein the first smart phone obtains the at least one connection information associated with the wireless network surveillance apparatus from a network connection tag of the wireless network surveillance apparatus.

19. The network surveillance system as recited in claim 18, wherein the at least one connection information comprises a connection password and a service set identifier of the network surveillance camera.

20. The network surveillance system as recited in claim 19, wherein the at least one connection information further comprises a unique identifier of the network surveillance camera.

21. The network surveillance system as recited in claim 20, wherein the first smart phone registers the network surveillance camera on the peer-to-peer communication server according to the unique identifier of the network surveillance camera.

22. The network surveillance system as recited in claim 21, wherein the first smart phone further accesses a surveillance image through the peer-to-peer communication server, the surveillance image being sent from the network surveillance camera to the peer-to-peer communication server.

23. The network surveillance system as recited in claim 17, wherein the first smart phone receives the access point list from the network surveillance camera, and the access point list comprises at least one access point searched by the network surveillance camera.

24. The network surveillance system as recited in claim 17, wherein the first smart phone searches at least one access point to generate the access point list comprising the at least one access point.

25. The network surveillance system as recited in claim 17, wherein when a second smart phone connected to the peer-to-peer communication server sends an access request to the peer-to-peer communication server for accessing a surveillance image captured by the network surveillance camera, the peer-to-peer communication server camouflages a data packet associated with the surveillance image as a hypertext transfer protocol packet and transmits the camouflaged data packet to the second smart phone.

26. The network surveillance system as recited in claim 17, wherein the peer-to-peer communication server and the network surveillance camera perform a handshake process through the specific access point, so as to open at least one communication port on the specific access point, and the at least one communication port is configured to send a surveillance image captured by the network surveillance camera.
